(19) United States
(12) Patent Application Publication
(10) Pub. No.: US 2010/0176730 A1
(43) Pub. Date: Jul. 15, 2010

(54) Illumination Apparatus

(76) Inventors: Young Hwan Lee, Seoul (KR); Kwan Soo Jang, Seoul (KR); CHung Hyun Cho, Goyang-si (KR)

Correspondence Address: THE LAW OFFICES OF ANDREW D. FORTNEY, PH.D., P.C., 215 W FALLBROOK AVE SUITE 203, FRESNO, CA, 93711, US

(21) Appl. No.: 12/684,846

(22) Filed: Jan. 8, 2010

(30) Foreign Application Priority Data
Jan. 13, 2009 (KR) 10-2009-0002525

(51) Int. Cl. H01J 13/32; H05B 39/00

(52) U.S. Cl. 315/113; 315/312; 313/504

(57) ABSTRACT

An illumination apparatus includes an adapter that is detachably and electrically connectable to a socket for a recessed light fitting; a power supply unit in the adapter to supply power; a light emitting device driver in the adapter that generates driving power from the power supplied by the power supply unit; a controller that controls the light emitting device driver; and a light emitting device illumination unit including a plurality of light emitting devices, the light emitting device illumination unit being connectable to the adapter and the light emitting devices receiving the driving power from the light emitting device driver.

The present application claims priority under 35 U.S.C. §119(e) of Korean Patent Application No. 10-2009-0002525 (filed on Jan. 13, 2009) which is hereby incorporated by reference in its entirety.

### BACKGROUND

### Description of the Related Art

The present disclosure relates to an illumination apparatus.

At the present time, a fluorescent lamp or an incandescent lamp has been widely used as an illumination apparatus. In particular, the fluorescent lamp has low power consumption and high brightness so that it has been widely used in the office and in the home.

Meanwhile, an illumination apparatus that replaces the fluorescent lamp or the incandescent lamp has been recently developed and, representatively, an illumination apparatus using a light emitting diode (LED) has been introduced. However, in the case of the illumination apparatus using the LED, it is driven with a different voltage than the fluorescent lamp or the incandescent lamp. As a result, power supply apparatuses including conventionally installed lamp sockets may not be useable with LED lamps.

### SUMMARY

The present disclosure provides an illumination apparatus with a new structure using an LED or an organic light emitting diode (OLED).

The present disclosure provides an illumination apparatus including an LED or an OLED that can be used without replacing the power supply apparatus or socket for an incandescent lamp or halogen lamp.

The present disclosure provides an illumination apparatus that can compatibly use various lamp sockets and power supplies by detachably installing an adapter and a lamp.

The present disclosure provides an illumination apparatus with improved heat emission and/or dissipation efficiency.

An illumination apparatus according to the present disclosure includes an adapter that is detachably and electrically connectable to a socket for (or in) a recessed light fitting; a power supply unit in the adapter to supply power; a light emitting device driver in the adapter, configured to generate driving power from the power supplied by the power supply unit; a controller configured to control the light emitting device driver; and a light emitting device illumination unit including a plurality of light emitting devices, connectable to the adapter and configured to receive the driving power from the light emitting device driver.

An illumination apparatus according to the present disclosure is installed in a recessed light fitting having a reflecting mirror therein, the illumination apparatus including an adapter that is detachably and electrically connectable to a socket for (or in) a recessed light fitting; a power supply unit in the adapter to supply power; a light emitting device driver in the adapter, configured to generate driving power from the power supplied by the power supply unit; a controller in the adapter, configured to control the light emitting device driver; and a light emitting device illumination unit including a substrate, a plurality of light emitting devices on the substrate, and a heat dissipating unit having one side or end that contacts the substrate and another side or end that contacts the reflecting mirror, the plurality of light emitting devices being electrically connected to the adapter and configured to receive the driving power from the light emitting device driver.

### BRIEF DESCRIPTION OF THE DRAWINGS

FIG. 1 is a diagram showing an example where an illumination apparatus according to the present disclosure is installed in a recessed light fitting;

FIG. 2 is an exploded view of an illumination apparatus according to the embodiment of FIG. 1;

FIG. 3 is a block diagram for explaining an exemplary configuration of the illumination apparatus according to various embodiments;

FIG. 4 is a diagram showing an exemplary AC-DC converter and an exemplary regulator for the present illumination apparatus;

FIG. 5 is a diagram showing an exemplary light emitting device driver and an exemplary light emitting device illumination unit for the present illumination apparatus;

FIG. 6 is a diagram showing a further exemplary light emitting device illumination unit for the illumination apparatus.

### DETAILED DESCRIPTION OF THE EMBODIMENTS

In the drawings, the thickness or size of each layer is exaggerated, omitted or schematically illustrated for convenience and clarity of explanation. Also, the size of each constituent does not completely reflect its actual size.

Hereinafter, an illumination apparatus according to various embodiments will be described with reference to the accompanying drawings.

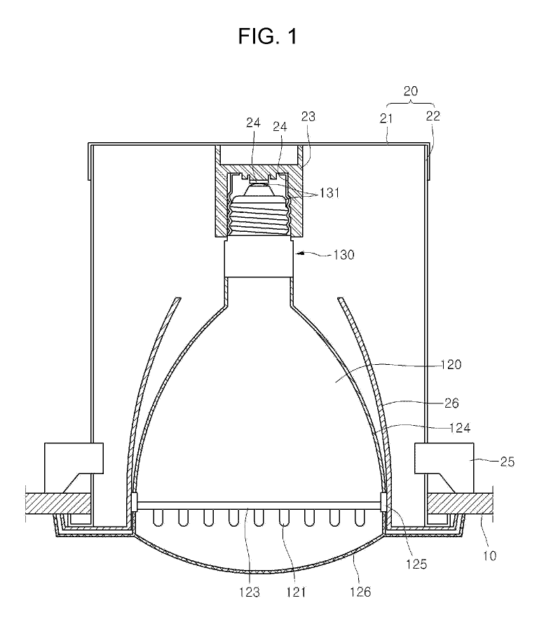

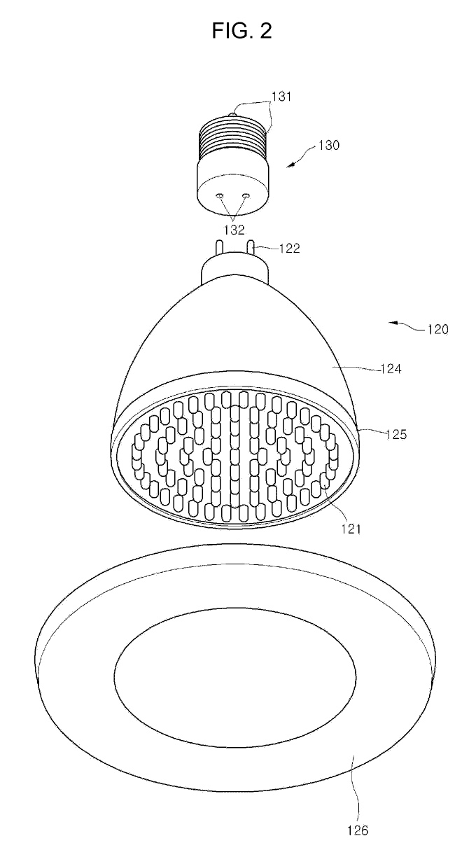

FIG. 1 is a diagram showing an example where an illumination apparatus according to the present disclosure is installed in a recessed light fitting, and FIG. 2 is an exploded view of the illumination apparatus according to the embodiment of FIG. 1.

Referring to FIGS. 1 and 2, the recessed light fitting includes a housing 20 that is connected to a ceiling panel 10 and a reflecting mirror 26 that is connected to and inserted into the housing 20.

The housing 20 includes an upper housing 21 having a socket 23 that is fixed to (or in) a central part thereof and a lower housing 22 that is connected to the housing 21 and fixed to the ceiling panel 10. The socket 23 includes a socket terminal 24 to supply power to the illumination apparatus. The lower housing 22 is fixed to the ceiling panel 10 by a fixing bracket 25, and the lower portion of the lower housing 22 extends beyond the lower side of the ceiling panel 10.

The reflecting mirror 26 is connected to the lower housing 22 for support, thereby increasing the light efficiency of the illumination apparatus in the recessed light fitting. For example, the reflecting mirror 26 may comprise an aluminum material having high reflectivity.

The recessed light fitting shown in FIG. 1 may have various structures and forms, and therefore, is not limited to the structure and form of FIG. 1. Meanwhile, the illumination apparatus according to the present disclosure may be installed in the recessed light fitting as shown in FIG. 1.

The illumination apparatus according to the present disclosure includes an adapter 130 that can be connected to the socket 23 in which an incandescent lamp or a halogen lamp can be installed, and a light emitting device illumination unit 120 that is detachably connected the adapter 130.

The adapter 130 has a spiral protrusion that complements and/or matches to the socket 111, a power supply terminal 131 that is electrically connectable to the socket terminal 24 and a connector groove (e.g., holes or a socket) 132 that is electrically connectable to the light emitting device illumination unit 120.

The light emitting device illumination unit 120 includes a connector or plug 122 that is inserted into the connector groove 132 of the adapter and is electrically connectable thereto, a first housing 124 through which the connector 122 extends, a heat dissipating unit 125 that is connected to the first housing 124, a substrate 123 that is connected to the heat dissipating unit 125 and/or the first housing 124, a plurality of light emitting devices 121 installed in or mounted on the substrate 123, and a second housing 126 that is connected to the heat dissipating unit 125, the substrate 123 and/or the first housing 124, and disposed at the lower side of the substrate 123.

The heat dissipating unit 125 may have high thermal conductivity. For example, the heat dissipating member 125 may comprise a continuous metal material forming a path of thermal conductance from the substrate 123 and/or housings 124, 126 away from the light emitting devices 121. The heat dissipating unit 125 rapidly transfers heat emitted from the plurality of light emitting devices 121 or the substrate 123 to outside the light emitting device illumination unit 120, thereby preventing the operational characteristics of the light emitting devices 121 from deteriorating due to heat.

The embodiment of FIG. 1 shows that the first housing 124 and the second housing 126 are connected to each other through the heat dissipating unit 125, but is not limited thereto. The heat dissipating unit 125 is disposed at a position adjacent to the substrate 123, making it possible to perform a heat transfer function. For example, the first housing 124 and the second housing 126 are directly connected to each other, and the heat dissipating unit 125 may be installed in part at a position adjacent to or in contact with the substrate 123.

In one embodiment, the heat dissipating unit 125 contacts the reflecting mirror 26 in the recessed lamp fitting. Since the reflecting mirror 26 may comprise an aluminum material having high reflectivity and thermal conductivity, when the heat dissipating unit 125 contacts the reflecting mirror 26, heat can be rapidly transferred to the outside from the reflecting mirror 26.

The substrate 123 may comprise a printed circuit board (PCB) having thereon a circuit pattern for providing and/or distributing power to the light emitting devices 121. In addition, the substrate 123 may be a substrate having thereon or therein wiring for providing power to the light emitting devices 121 (e.g., to a plastic instrument). The substrate 123 (or the circuit pattern or wiring thereof) is electrically connectable to the connector 122.

In addition, the reflective coating layer (not shown) may be formed on the surface of the substrate 123 (e.g., by sputtering or evaporation), making it possible to increase efficiency of light emitted from the light emitting devices 121. The coating may comprise silver (Ag) or aluminum (Al).

In the embodiment shown, the substrate 123 has a plate shape and is installed, affixed or mounted inside the first housing 124 and the second housing 126.

The light emitting devices 121 may comprise a plurality of LEDs or OLEDs. For example, each light emitting device 121 may be an LED or an OLED that emits red, blue, green, white, yellow, orange, purple, violet, or ultraviolet light. The light emitting devices 121 may include groups or subsets of light emitting devices, each group or subset emitting a different color of light.

The second housing 126 may comprise or consist essentially of a transparent plastic material and may have one or more various colors such as red, green, blue, etc. In addition, the second housing 126 may comprise or consist essentially of a translucent material, and in this case, it may also provide an illumination with a soft atmosphere.

The illumination apparatus according to the present disclosure may be installed in the socket 111 of a recessed light fitting for an existing incandescent lamp or halogen lamp by connecting the light emitting device illumination unit 120 and the adapter 130. In addition, in the present illumination apparatus, the adapter 130 converts AC power to the existing incandescent lamp or halogen lamp into DC power, thereby making it possible to drive the light emitting devices 121. Therefore, the illumination apparatus can use LEDs or OLEDs without replacing the power supply apparatus including the socket 23 for existing incandescent lamps or halogen lamps.

In particular, since the light emitting device illumination unit 120 and the adapter 130 are detachably installed, when defects arise in the light emitting device illumination unit 120 or the adapter 130, only the defective light emitting device illumination unit 120 or adapter 130 is replaced. As a result, the present illumination apparatus may have relatively low maintenance costs.

In addition, the illumination apparatus according to the present disclosure has an advantage in that a variety of illumination atmospheres can be created or generated by replacing only the light emitting device illumination unit 120, since the light emitting device illumination unit 120 and the adapter 130 are detachably installed.

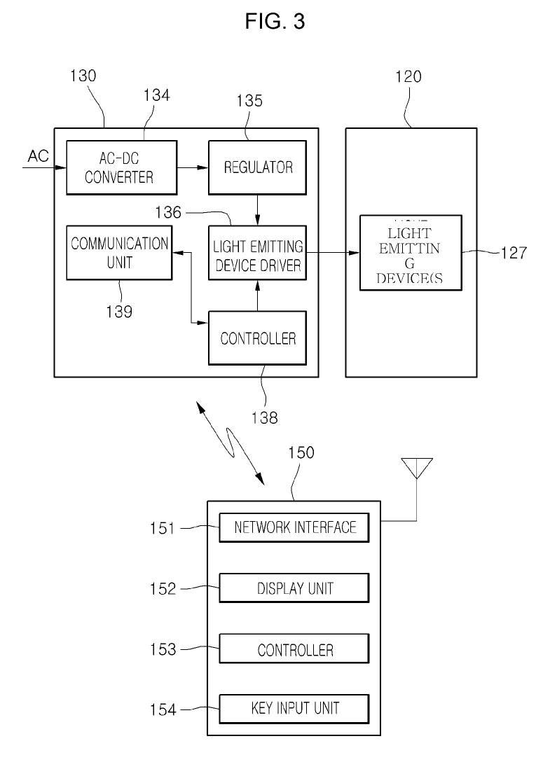

FIG. 3 is a block diagram for explaining an exemplary configuration of the present illumination apparatus according to various embodiments.

Referring to FIG. 3, the adapter 130 may include an AC-DC converter 134, a regulator 135, a light emitting device driver 136, a controller 138, and a communication unit 139. The light emitting device illumination unit 120 may include one or more light emitting device units 127 (each comprising one or more light emitting devices 121; not shown).

In more detail, the power supply unit that supplies power in the adapter 130 includes the AC-DC converter 134 and the regulator 135. The AC-DC converter 134 converts the AC power supplied through the socket 23 into DC power, and the regulator 135 can output the DC power from the AC-DC converter 134 at a predetermined DC voltage.

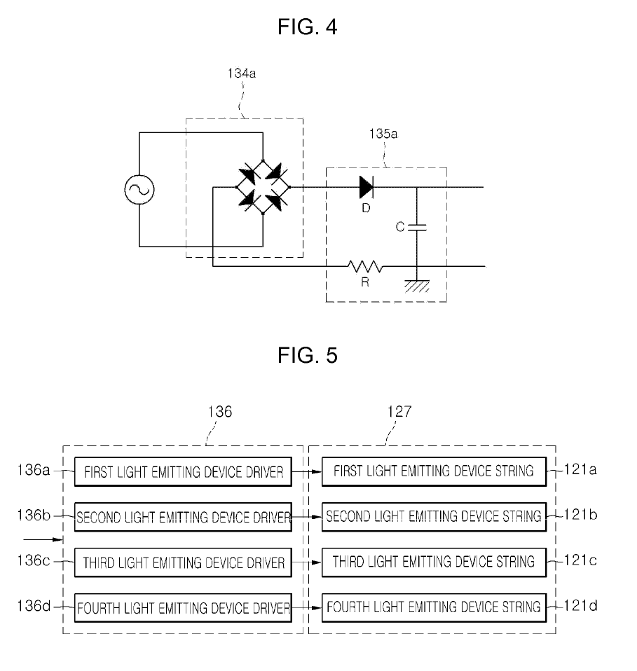

For example, as shown in FIG. 4, the AC-DC converter 134 and the regulator 135 may include a bridge rectifying circuit 134a and a smoothing (or filter) circuit 135a, comprising a diode D, a resistor R, and a capacitor C coupled between the outputs of the diode and the resistor (which may be upper and lower DC power supplies for the light emitting device driver 136).

Referring back to FIG. 3, the light emitting device driver 136 outputs the DC voltage from the regulator 135 as a driving power suitable to drive the plurality of light emitting devices 121. In various embodiments, the drive signals for driving the plurality of light emitting devices 21 comprise one or more driving pulses.

As shown in FIG. 5, the exemplary light emitting device driver 136 may include a first light emitting device driver 136a, a second light emitting device driver 136b, a third light emitting device driver 136c, and a fourth light emitting device driver 136d. Each of the first light emitting device driver 136a, the second light emitting device driver 136b, the third light emitting device driver 136c, and the fourth light emitting device driver 136d may respectively and/or independently drive a respective subset of the light emitting devices 121 (e.g., first light emitting device string 121a, second light emitting device string 121b, third light emitting device string 121c, and fourth light emitting device string 121d) in the light emitting device unit 127.

For example, the first light emitting device string 121a may comprise a plurality of LEDs or OLEDs connected in series that emit red light, the second light emitting device string 121b may comprise a plurality of LEDs or OLEDs connected in series that emit green light, the third light emitting device string 121c may comprise a plurality of LEDs or OLEDs connected in series that emit blue light, and the fourth light emitting device string 121d may comprise a plurality of LEDs or OLEDs connected in series that emit white light.

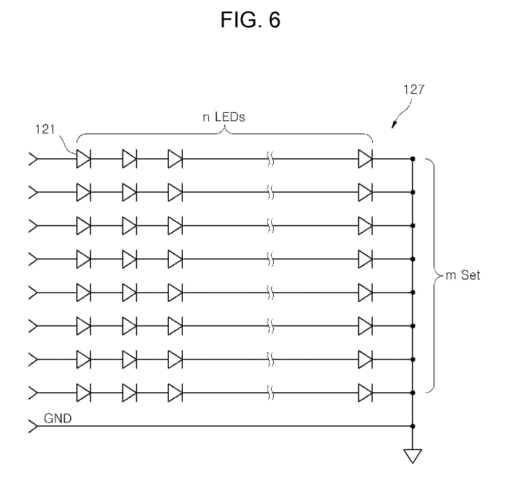

For example, as shown in FIG. 6, the light emitting device unit 127 may include a plurality of light emitting devices 121, and the plurality of light emitting devices 121 can form the plurality of light emitting device strings 121a-121d as shown in FIG. 5. For example, FIG. 6 shows m LED strings to which n LEDs are connected in series, wherein m is an integer of at least 1 (e.g., from 2 to 7), and n is an integer of at least 2. When m is 1, the LED(s) 121 may emit white light. When m is 2, the LED(s) 121 may emit white light and another color or light, such as red, green or blue light. When m is 3, the LED(s) 121 may emit red, green and blue light. When m is 4, the LED(s) 121 may emit white, red, green and blue light. When m is 7, the LED(s) 121 may emit white, red, green, blue, yellow, orange and violet light. Alternatively or additionally, the LED(s) 121 may emit ultraviolet or infrared light.

The exemplary light emitting device driver 136 in FIG. 5 comprises a first light emitting device driver 136a, a second light emitting device driver 136b, a third light emitting device driver 136c, and a fourth light emitting device driver 136d to control the length, on-off interval (e.g., cycle), power (e.g., voltage and/or current), etc., of the driving pulse(s) for the first light emitting device string 121a, the second light emitting device string 121b, the third light emitting device string 121c, and the fourth light emitting device string 121d, thereby causing the light emitting device unit 127 to emit light having one or more various colors and/or patterns.

For example, when the driving pulse is applied to only the first light emitting device string 121a by driving only the first light emitting device driver 136a, the light emitting device illumination unit 120 may emit red light. Further, when the driving pulse is applied to only the fourth light emitting device string 121d by driving only the fourth light emitting device driver 136d, the light emitting device illumination unit 120 light may emit white light. Moreover, when all of the first through fourth light emitting device drivers 136a-136d apply driving pulses to the first through fourth light emitting device strings 121a-121d, the light emitting device illumination unit 120 emits more white light.

Referring back to FIG. 3, the controller 138 controls the light emitting device driver 136 (e.g., the first light emitting device driver 136a, the second light emitting device driver 136b, the third light emitting device driver 136c, and the fourth light emitting device driver 136d, as shown in FIG. 5) to drive the various light emitting devices 121 (e.g., first light emitting device string 121a, the second light emitting device string 121b, the third light emitting device string 121c, and the fourth light emitting device string 121d). For example, the controller 138 can provide different driving pulse information to different light emitting device drivers (e.g., the first light emitting device driver 136a, the second light emitting device driver 136b, the third light emitting device driver 136c, and the fourth light emitting device driver 136d), thereby making it possible to vary the color, brightness, saturation, flickering (e.g., on-off cycles), pattern, etc., of light emitted from the plurality of light emitting devices 121.

The communication unit 139 communicates with a remote controller 150, and the controller 138 can be remotely controlled by the remote controller 150. The communication unit 139 and the remote controller 150 can communicate according to a wireless communication scheme, for example, a Zigbee standard.

The remote controller 150 includes a network interface 151 that transmits data to the communication unit 139, a key input unit 154 that inputs an operational command or instruction from a user, a display unit 152 that shows an operational state of the illumination apparatus and/or a pending instruction to the user, and a controller 153 that controls the network interface 151 and the display unit 152 according to the signals from the key input unit 154 and/or communication unit 139. Therefore, the user can transmits control commands to the communication unit 139 using the remote controller 150, and the communication unit 130 can transmit the control commands from the user to the controller 138, thereby making it possible to control the light emitting device illumination unit 120.

As described above, the illumination apparatus according to the present disclosure can be also used in the power supply apparatus for existing fluorescent lamps or halogen lamps that supply AC power to the adapter 130 including the AC-DC converter 134, the regulator 135, and the light emitting device driver 136.

In addition, the illumination apparatus according to the present disclosure can be remotely controlled using the adapter 130 that includes the communication unit 139 performing communication with the remote controller 150.

The present disclosure can provide an illumination apparatus using LEDs and/or OLEDs.

The present disclosure provides an illumination apparatus including LEDs and/or OLEDs that can be used without replacing the power supply apparatus for an incandescent lamp or a halogen lamp.

The present disclosure can provide the illumination apparatus that can compatibly use various lamps by detachably installing the adapter and the lamp.

The present disclosure can provide the illumination apparatus with improved heat emission, transfer and/or dissipation efficiency.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is within the purview of one skilled in the art to effect such feature, structure, or characteristic in connection with other embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An illumination apparatus, comprising:
an adapter that is detachably and electrically connectable to a socket for or in a recessed light fitting;
a power supply unit in the adapter to supply power;
a light emitting device driver in the adapter configured to generate driving power from power supplied by the power supply unit;
a controller configured to control the light emitting device driver; and
a light emitting device illumination unit including a plurality of light emitting devices, the light emitting device illumination unit being connectable to the adapter, and the plurality of light emitting devices being configured to receive the driving power from the light emitting device driver.

2. The illumination apparatus according to claim 1, wherein the adapter comprises a connector groove or socket, and the light emitting device illumination unit comprises a connector, the connector being connectable or insertable into the connector groove or socket.

3. The illumination apparatus according to claim 1, wherein the light emitting devices each comprise an LED or an OLED.

4. The illumination apparatus according to claim 1, wherein the light emitting device illumination unit further includes a first housing connected to the adapter.

5. The illumination apparatus according to claim 4, wherein the light emitting device illumination unit further includes a second housing connected to the first housing.

6. The illumination apparatus according to claim 5, wherein the first housing and the second housing together enclose the light emitting device illumination unit.

7. The illumination apparatus according to claim 4, wherein the light emitting device illumination unit further includes a substrate supported on or attached or affixed to the first housing and/or the second housing.

8. The illumination apparatus according to claim 7, wherein the substrate has a shape defined by the space in the first housing and/or the second housing.

9. The illumination apparatus according to claim 7, wherein the plurality of light emitting devices areon the substrate.

10. The illumination apparatus according to claim 7, further comprising a heat dissipating member on the first housing and/or the second housing that contacts the substrate.

11. The illumination apparatus according to claim 10, wherein the heat dissipating unit has one side or end contacting the substrate and another side or end exposed outside the light emitting device illumination unit.

12. The illumination apparatus according to claim 10, wherein the heat dissipating unit comprises a metal material.

13. The illumination apparatus according to claim 5, wherein the second housing comprises a translucent material.

14. An illumination apparatus, comprising:
a recessed light fitting having a socket therein;
a reflecting mirror in the recessed light fitting;
an adapter that is detachably and electrically connectable to the socket;
a power supply unit in the adapter to supply power;
a light emitting device driver in the adapter, configured to generate driving power from the power supplied by the power supply unit;
a controller in the adapter, configured to control the light emitting device driver; and
a light emitting device illumination unit including a substrate, a plurality of light emitting devices thereon, and a heat dissipating unit having one side or end that contacts the substrate and another side or end that contacts the reflecting mirror, the plurality of light emitting devices being electrically connectable to the adapter and configured to receive the driving power from the light emitting device driver.

15. The illumination apparatus according to claim 14, wherein the adapter and the light emitting device illumination unit are detachably connectable to each other.

16. The illumination apparatus according to claim 14, wherein each light emitting device comprises an LED or an OLED.

17. The illumination apparatus according to claim 14, wherein the light emitting device illumination unit includes a first housing provided with a connector that is connectable to the adapter.

18. The illumination apparatus according to claim 17, wherein the light emitting device illumination unit further includes a second housing connectable to the first housing, wherein the substrate is in a space defined by the first housing and/or the second housing.

19. The illumination apparatus according to claim 18, wherein the heat dissipating unit is supported on or attached or affixed to the first housing and/or the second housing.

20. The illumination apparatus according to claim 18, wherein the second housing comprises a translucent material.
